(19) United States
(12) Patent Application Publication
(10) Pub. No.: US 2026/0366892 A1
(43) Pub. Date: Nov. 19, 2026

(54) OPTICAL ENCODER MECHANISM FOR DECREASING DIRECT INTERNAL LIGHT REFLECTION AND LIGHT CROSSTALK FROM GLASS COVER

(71) Applicant: PixArt Imaging Inc., Hsin-Chu City (TW)

(72) Inventors: Tze Wei Priscilla GOH, Penang (MY); Chee Pin T'Ng, Penang (MY); Sai Mun Lee, Penang (MY)

(73) Assignee: PixArt Imaging Inc., Hsin-Chu City (TW)

(21) Appl. No.: 19/206,079

(22) Filed: May 13, 2025

(51) Int. Cl. G01D 5/347; G01D 11/26

(52) U.S. Cl. CPC G01D 5/34715; G01D 5/3473; G01D 11/26

(57) ABSTRACT

An optical encoder device paired with an external code wheel device includes a housing, a specific aperture design to fit a specific glass cover, an optical encoder chip, a light emission unit for emitting a light ray transmitted from the light emission unit into the external code wheel device through an air gap and the specific glass cover, at least one photo diode array for receiving and sensing the light ray reflected from the external code wheel device and penetrated through the specific glass cover, and at least one partition unit configured and placed between the light emission unit and the at least one photo diode array to block an internal light ray directed transmitted into the at least one photo diode array and to decrease a light refraction from the specific glass cover emitted by the light emission unit.

### BACKGROUND OF THE INVENTION

### 1. Field of the Invention

The invention relates to an optical encoder mechanism, and more particularly to an optical encoder device and a corresponding method.

### 2. Description of the Prior Art

Generally speaking, the performance of a conventional optical encoder is easily affected by the internal stray light since the internal stray light will become the static noise made to a photo diode array and degrade the signal-to-noise ratio (SNR) and optical signal contrast.

### SUMMARY OF THE INVENTION

Therefore one of the objectives of the invention is to provide an optical encoder device and a corresponding method, to solve the problems. The invention disclosure describes the design and construction of an optical encoder device with a glass cover that improves or minimizes the direct light internal reflection and crosstalk from a plain glass cover.

According to the embodiments of the invention, an optical encoder device, to be paired with an external code wheel device, is disclosed. The optical encoder device comprises a housing, a specific aperture design, an optical encoder chip, a light emission unit, at least one photo diode array, and at least one partition unit. The specific aperture design is on a top of the housing and used for fitting a specific glass cover. The optical encoder chip is placed within an inner space of the housing. The light emission unit is placed on an area of the optical encoder chip and used for emitting a light ray transmitted from the light emission unit into the external code wheel device through an air gap and the specific glass cover, and the air gap is between the specific glass cover and the light emission unit. The at least one photo diode array is used for receiving and sensing the light ray reflected from the external code wheel device and penetrated through the specific glass cover. The at least one partition unit is configured and placed between the light emission unit and the at least one photo diode array, and is used for blocking an internal light ray directed transmitted into the at least one photo diode array and for decreasing a light refraction from the specific glass cover emitted by the light emission unit.

According to the embodiments, a method of an optical encoder device, to be paired with an external code wheel device, is disclosed. The method comprises: providing a housing; providing a specific aperture design on a top of the housing to fit a specific glass cover; providing and placing an optical encoder chip within an inner space of the housing; placing a light emission unit on an area of the optical encoder chip to emit a light ray transmitted from the light emission unit into the external code wheel device through an air gap and the specific glass cover, the air gap being between the specific glass cover and the light emission unit; providing at least one photo diode array to receive and sense the light ray reflected from the external code wheel device and penetrated through the specific glass cover; placing at least one partition unit between the light emission unit and the at least one photo diode array to block an internal light ray directed transmitted into the at least one photo diode array and to decrease a light refraction from the specific glass cover emitted by the light emission unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a plan view diagram of an optical encoder device according to an embodiment of the invention.

FIG. 2 is a three-dimensional (3D) view diagram of the optical encoder device prior to the installation of a glass cover according to an embodiment of the invention.

FIG. 3 is a three-dimensional (3D) view diagram of the optical encoder device after a glass cover has been installed according to an embodiment of the invention.

FIG. 4 is a cross-section diagram of an optical encoder device according to another embodiment of the invention.

FIG. 5 is a cross-section diagram of an optical encoder device according to another embodiment of the invention.

FIG. 6 is a cross-section diagram of an optical encoder device according to another different embodiment of the invention.

### DETAILED DESCRIPTION

The invention aims at providing a design and construction of a robust optical encoder device with a specific glass cover to reduce the direct internal light reflection and crosstalk from a plain glass of the specific glass cover. Specifically, the invention provides multiple embodiments having different design solutions which can be implemented to reduce the direct internal light reflection and crosstalk for the product of a stacked die of the robust optical encoder device with the specific glass cover.

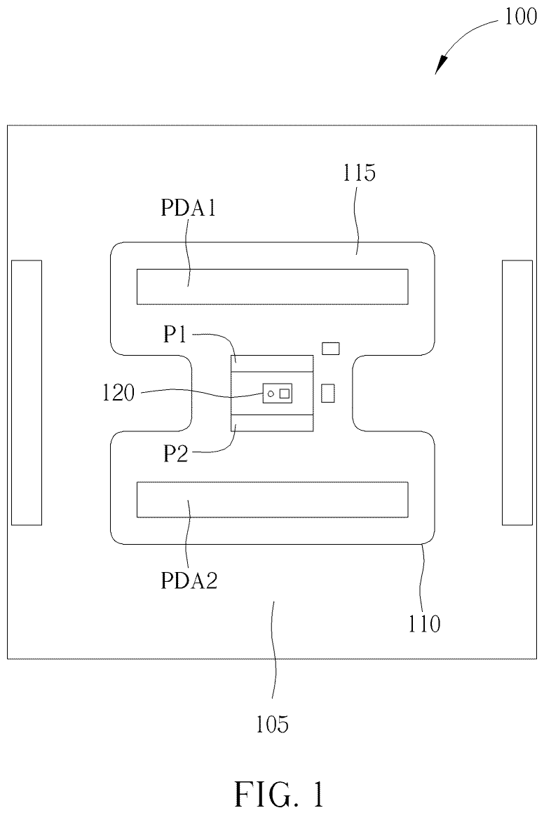

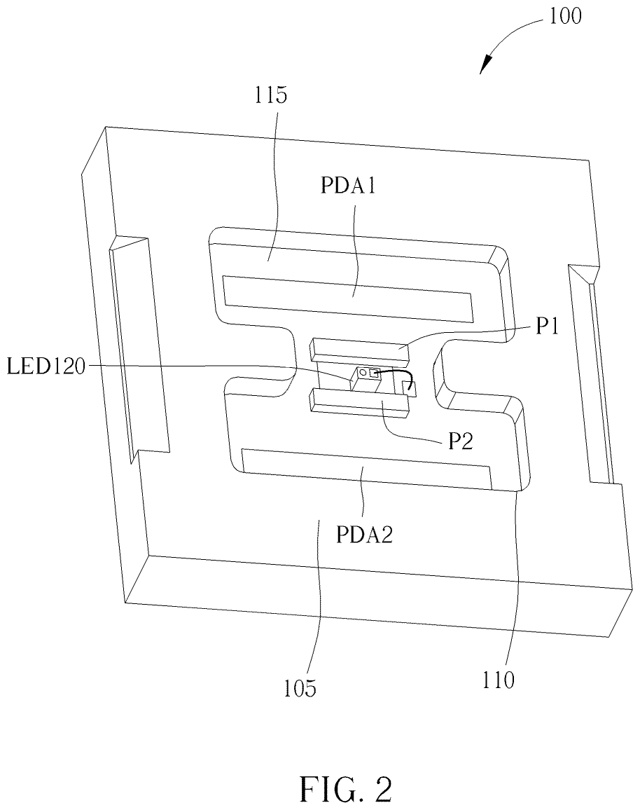

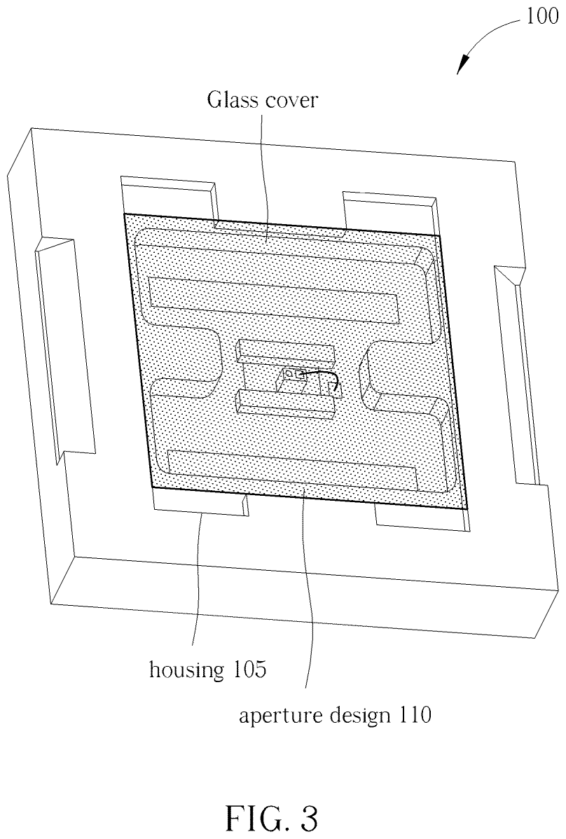

Refer to FIG. 1, FIG. 2, and FIG. 3. FIG. 1 is a plan view diagram of an optical encoder device 100 according to an embodiment of the invention. FIG. 2 is a three-dimensional (3D) view diagram of the optical encoder device 100 prior to the installation of a glass cover according to an embodiment of the invention. FIG. 3 is a three-dimensional (3D) view diagram of the optical encoder device 100 after a glass cover has been installed according to an embodiment of the invention.

As shown in FIG. 1 and in FIG. 2, the optical encoder device 100 has multiple partition units, e.g. partition bridges/walls which are used as blockages to separate the light emission unit 120 from the stray light, so as to reduce the direct light internal reflection and crosstalk from a plain glass cover. For example, the optical encoder device 100 for example may be an optical encoder package device to be paired with an external code wheel device, and it comprises a housing 105, a specific aperture design 110 which is on a top of the housing 105 and can fit to a specific cover such as a glass cover, an optical encoder chip (or chip circuit) 115 placed within an inner space of the housing 105, a light emission unit 120 such as light emission diode (LED) stacked on the optical encoder chip 115, at least one photo diode array such as photo diode arrays PDA1 and/or PDA2, and at least one partition unit such as partition bridges/walls P1 and/or P2.

The implementation of the glass cover for the optical encoder device 100 is critical for contamination robustness. The optical encoder device 100 can be used in many industrial applications, and it is prone to dust and particles. The glass cover enables the user to clean and protects the contamination on the detection of photo diode arrays. The light emission unit 120 is placed on an area of the optical encoder chip 115 and is used for emitting a light ray transmitted from the light emission unit 120 into the external code wheel device through an air gap and the specific glass cover; the air gap is between the specific glass cover and the light emission unit 120.

In addition, the at least one photo diode array PDA1 and/or PDA2 is/are used for receiving and sensing the light ray reflected from the external code wheel device and penetrated through the specific glass cover. The at least one partition unit P1 and/or P2, configured and placed between the light emission unit 120 and the at least one photo diode array PDA1 and/or PDA2, is/are used for blocking an internal light ray directed transmitted into the at least one photo diode array PDA1 and/or PDA2 and for decreasing a light refraction from the specific glass cover emitted by the light emission unit 120. The partition bridge P1, placed between the photo diode array PDA1 and the light emission unit 120, is used to separate a direct light emission from the light emission unit 120 into the photo diode array PDA1, and the partition bridge P2, placed between the photo diode array PDA2 and the light emission unit 120, is used to separate a direct light emission from the light emission unit 120 into the photo diode array PDA2. The number of partition bridges/walls is equal to the number of the photo diode arrays; however, this is not intended to be a limitation.

The optical encoder device 100 has the aperture design 110 with the partition bridges P1 and P2 as shown in FIG. 1 and FIG. 2. For example (but not limited), the aperture design 110 indicates an “I-beam” or “H-beam” shape which has horizontal lines at the top and bottom connected by a vertical line in the middle; it shows the “I-beam” shape when viewed from the side or shows the “H-beam” shape when viewed from the end. The shape of aperture design 110 allows the LED 120 emitting light rays onto an external code wheel device through the specific glass cover and allows the multiple photo diode arrays PDA1 and PDA2 receiving and sensing the reflected light rays from the external code wheel device through the specific glass cover, and then the optical encoder chip 115 can detect the rotation angle (or rotation direction) of the external code wheel device based on the images of the reflected light rays. It should be noted that the shape of the aperture design 110 is not intended to be a limitation, and the shape can be different in other embodiments.

In addition, the photo diode arrays PDA1 and PDA2 may be different types, e.g. an “AB” photodiode array and an absolute/index photodiode array; the absolute/index photodiode array may be called a Z-channel or reference photodiode array. The “AB” photodiode array refers to an arrangement of photodiodes that generate two quadrature output signals (called A and B signals) which are 90 degrees out of phase with each other. The photo diode array PDA1 for example is the “AB” photodiode array to detect the direction of rotation of the external code wheel device by determining which channel leads the other, detect the position of the rotation by counting pulses, and detect the speed of the rotation by measuring the pulse frequency. Additionally, the photo diode array PDA2 for example is the absolute/index photodiode which serves as a reference point that provides a single pulse per revolution. The photo diode array PDA2 may provide/generate a reliable zero position reference, enable the absolute position determination after power-up, allow for counting complete revolutions, and help correct any accumulated counting errors from the AB channels of the photo diode array PDA1. In applications, the index pulse generated by the photo diode array PDA2 is used during a system initialization to establish a starting position, and then during the operation it can be used to verify the position accuracy by checking that the expected number of AB pulses occurred between the index pulses.

The optical effect of having the glass cover placed at the aperture design 110 may result in additional internal light reflection from the glass cover and stray light. The stray light from LED 120 and internal reflection from the glass cover may become the static noise to the optical detection. The two partition bridges/walls P1 and P2 can make the photo diode arrays PDA1 and PDA2 receive and sense a cleaner signal, and thus, the optical encoder device 100 can provide a reliable and accurate feedback for movement control and positioning. In FIG. 1 and FIG. 2, the two partition bridges/walls P1 and P2 are respectively placed and configured in between the LED 120 and the corresponding photo diode arrays PDA1 and PDA2, to be used as blockages to block the stray light so as to reduce the direct internal light reflection and crosstalk from the plain glass of the glass cover, thereby reducing the static noise and improving the SNR and optical signal contrast.

The length of the partition bridge P1 is configured to be enough long to avoid direct internal light emitted from the LED 120 into the two ends of the photo diode array PDA1, and similarly the length of the partition bridge P2 is configured to be enough long to avoid direct internal light emitted from the LED 120 into the two ends of the photo diode array PDA2. In this embodiment, the two ends of the photo diode array PDA1 (or the two ends of the photo diode array PDA2) may not contact with any portion of the surrounding (or surrounding walls) of the aperture design 110. In other embodiments, the two ends of the photo diode array PDA1 (or the two ends of the photo diode array PDA2) may make contact with portions of the surrounding walls of the aperture design 110. That is, in this situation, the length of the partition bridge P1 (or P2) may be equal to the inner middle width of the “I-beam” or “H-beam” shape of aperture design 110.

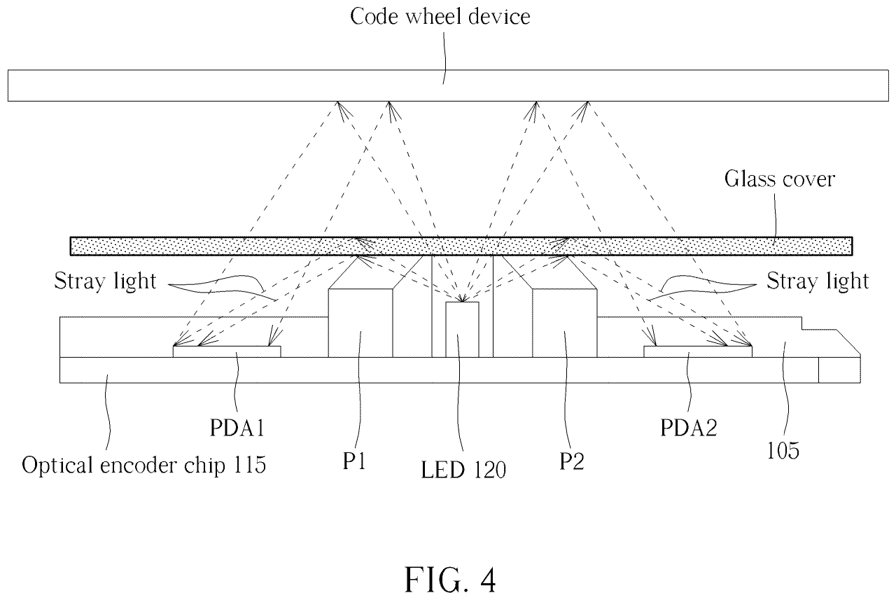

FIG. 4 is a cross-section diagram of an optical encoder device 100 according to another embodiment of the invention. In this embodiment, the glass cover after packing onto the optical encoder device 100 is equivalently positioned at a first horizontal plane that is parallel to a second horizontal plane at which the optical encoder chip 115 is positioned. The two partition bridges/walls P1 and P2, respectively placed between the LED 120 and corresponding photo diode arrays PDA1 and PDA2, are configured to have first and second partial heights which are enough taller/higher than the height of the LED 120 to avoid the inner direct light rays emitting from the LED 120 into the photo diode arrays PDA1 and PDA2.

In addition, in this embodiment, the partial height indicates that the top portions of two partition bridges/walls P1 and P2 do not touch/contact the bottom surface of the glass cover. It becomes easy to pack the glass cover onto the optical encoder device 100. As shown in FIG. 4, a larger portion of light rays, emitted from the LED 120 and not blocked by the two partition bridges/walls P1 and P2, may transmit/penetrate through the glass cover, then may be reflected by the external code wheel device, and then may be received and sensed by the photo diode arrays PDA1 and PDA2 respectively. Only a smaller portion of light rays, emitted from the LED 120 and not blocked by the two partition bridges/walls P1 and P2, may be refracted through the glass cover and then may be sensed by the photo diode arrays PDA1 and PDA2. Thus, to avoid the direct light emission, the embodiment of FIG. 4 can improve the performance of the optical encoder device 100.

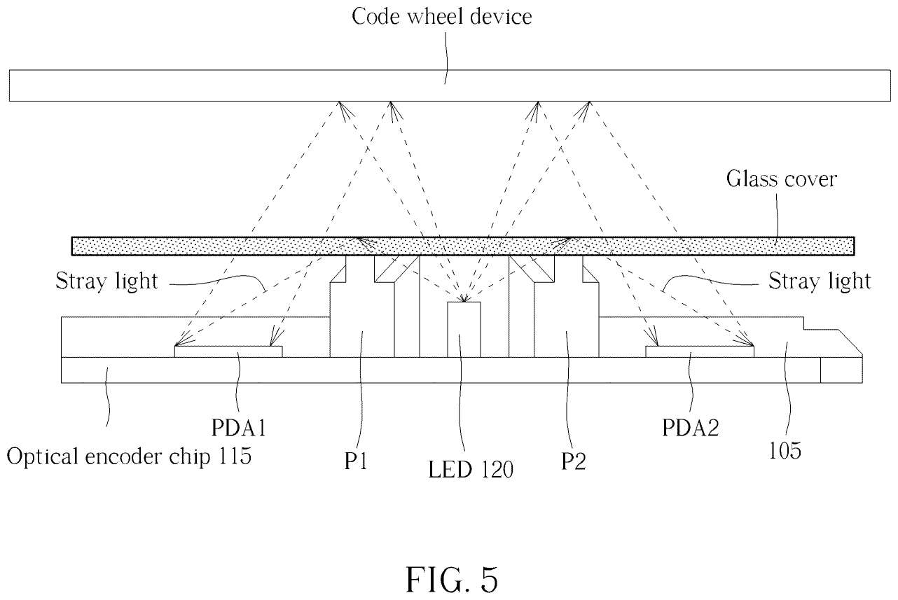

FIG. 5 is a cross-section diagram of an optical encoder device 100 according to another embodiment of the invention. In this embodiment, similarly, the glass cover after packing onto the optical encoder device 100 is equivalently positioned at a first horizontal plane that is parallel to a second horizontal plane at which the optical encoder chip 115 is positioned. The two partition bridges/walls P1 and P2, respectively placed between the LED 120 and corresponding photo diode arrays PDA1 and PDA2, are configured to have first and second full heights which are enough taller/higher than the height of the LED 120 to avoid the inner direct light rays emitting from the LED 120 into the photo diode arrays PDA1 and PDA2. In addition, in this embodiment, the full height indicates that the top portions of two partition bridges/walls P1 and P2 exactly touch/contact the bottom surface of the glass cover. As shown in FIG. 5, a larger portion of light rays, emitted from the LED 120 and not blocked by the two partition bridges/walls P1 and P2, may transmit/penetrate through the glass cover, then may be reflected by the external code wheel device, and then may be received and sensed by the photo diode arrays PDA1 and PDA2 respectively. Only little portion of light rays, emitted from the LED 120 and not blocked by the two partition bridges/walls P1 and P2, may be refracted through the glass cover and then may be sensed by the photo diode arrays PDA1 and PDA2. Thus, to avoid the direct light emission and also avoid some light refraction, the embodiment of FIG. 5 can significantly improve the performance of the optical encoder device 100.

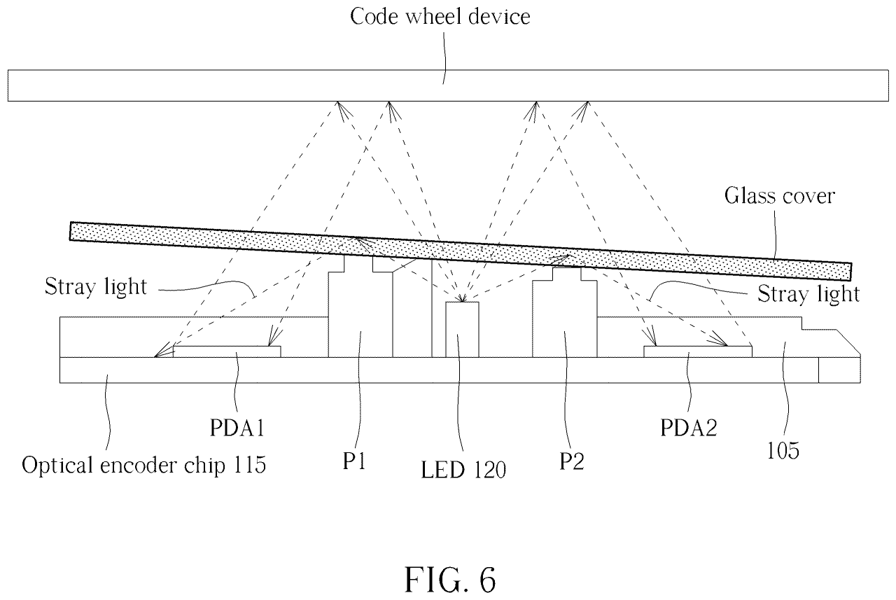

FIG. 6 is a cross-section diagram of an optical encoder device 100 according to another different embodiment of the invention. In this embodiment, the glass cover is tilted with a tilted angle to be packed onto the optical encoder device 100 and to fit the aperture design 110, and for example it is equivalently positioned/located at a third plane that is tilted and is not parallel to the second horizontal plane at which the optical encoder chip 115 is positioned/located.

The two partition bridges/walls P1 and P2, respectively placed between the LED 120 and corresponding photo diode arrays PDA1 and PDA2, are configured to have different heights which are enough taller/higher than the height of the LED 120 and can make the glass cover after package be tiled, to avoid the inner direct light rays emitting from the LED 120 into the photo diode arrays PDA1 and PDA2 and avoid some light refractions. For example, in FIG. 6, the height of partition bridge/wall P1 is higher than that of partition bridge/wall P2 to make the glass cover be tilted towards one side of the partition bridge/wall P2. In addition, in this embodiment, the top portions of two partition bridges/walls P1 and P2 may exactly touch/contact different portions of the bottom surface of the glass cover; however, this is not intended to be a limitation.

As shown in FIG. 6, a larger portion of light rays, emitted from the LED 120 and not blocked by the two partition bridges/walls P1 and P2, may transmit/penetrate through the glass cover, then may be reflected by the external code wheel device, and then may be received and sensed by the photo diode arrays PDA1 and PDA2 respectively. Only little portion of light rays, emitted from the LED 120 and not blocked by the two partition bridges/walls P1 and P2, may be refracted through the glass cover, and some portions of the light refraction are not transmitted into at least one of the photo diode arrays PDA1 and PDA2 due to the tilted glass cover. For example (but not limited), in FIG. 6, the light refraction may not be transmitted into and sensed by the photo diode array PDA1. Thus, to avoid the direct light emission and also avoid a larger portion of light refractions, the embodiment of FIG. 6 can significantly improve the performance of the optical encoder device 100.

Specifically, in the embodiment of FIG. 6, the plain glass cover is to be placed at a tilted angle related to the photo diode arrays PDA1 and PDA2 to redirect the internal light crosstalk out of the region of interest (ROI) or region of detection of the photo diode arrays PDA1 and PDA2. This can provide a better contrast for signals. For example (but not limited), the internal reflection light is redirected out from the photo diode array PDA1. In one embodiment, the internal reflection light may be redirected out from the photo diode array PDA2. For instance, for the “AB” channels of the photo diode array PDA1, the “AB” channels of sine and cosine signal need to be at a better contrast, and the aperture design which makes the plain glass cover be tilted at a tilted angle can redirect the crosstalk light refraction from away the region of interest/detection of the “AB” channels of photo diode array PDA1, as shown in FIG. 6.

Further, it should be noted that the shape of the aperture design is not intended to be a limitation, and the shape can be different in other embodiments. In addition, the signal quality of an optical encoder device is dependent on the optical contrast that the optical encoder vice is able to achieve when pairing with a reflective code wheel device. The optical contrast is a function of a normalized difference between the intensity of reflected light by the code wheel device and the surrounding light. The lower the amount of internal light reflection and light crosstalk from the glass Cover, the lower the noise level caused to the photo diode arrays PDA1 and PDA2. Thus, the optical encoder device 100 is able to provide a higher contrast and higher resolvability of the bright and dark images reflected from the code wheel device. By doing so, the embodiments of the invention can use the partition bridges/walls P1 and P2 to eliminate (or minimize) light leakage and crosstalk through the air gap to the glass piece so as to provide a better signal contrast for the reflected code wheel image pattern, and thus the performance of optical encoder device 100 can be significantly improved.

Additionally, in other embodiments, an anti-reflection (AR) coating (or AR coating material), e.g. an ultra-thin AR coating layer, may be applied into the specific plain glass cover to reduce or decrease the light reflectivity/reflection and scattering of the plain glass cover. The anti-reflection coating applied on the plain glass cover of the optical encoder device 100 can decrease the internal reflection within the system of optical encoder device 100 and improves the transmission to the reflective code wheel device. This provides a more efficient optical imaging system as less light is loss. The AR coating material/layer can applied into the plain glass cover in the embodiments of FIG. 1, FIG. 4, FIG. 5, and FIG. 6.

To make readers more clearly understand the performance improved by the embodiments of the invention. In the following, a comparison table of the overall contrast and system efficiency of results for the prior art method and the embodiments of the invention is provided:

| Simulation result | | | PDA2 with index/ | |
|---|---|---|---|---|
| of optical contrast | PDA1 with “AB” channels | | absolute channel | |
| with/without AR | | AR-coated | | AR-coated |
| coating glass | Plain glass | glass | Plain glass | glass |
| Conventional | 22% | 35% | 22% | 35% |
| optical encoder | | | | |
| Optical | 47% | 62% | 49% | 62% |
| encoder of FIG. 4 | | | | |
| Optical | 70% | 71% | 71% | 72% |
| encoder of FIG. 5 | | | | |
| Optical | 72% | 72% | 71% | 72% |
| encoder of FIG. 6 | | | | |

As mentioned above, the optical contrast from the reflective code wheel device can be significantly increased in the embodiments of the invention with/without the AR coating compared to the conventional optical encoder. Further, the embodiments of the invention in FIG. 4, FIG. 5, and FIG. 6 can be implemented individually or in any combination to minimize the direct light internal reflection and crosstalk from the plain glass cover for an optical encoder device based on different design requirements and constraints.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical encoder device, to be paired with an external code wheel device, and the optical encoder device comprises:
a housing;
a specific aperture design on a top of the housing, for fitting a specific glass cover;
an optical encoder chip, placed within an inner space of the housing;
a light emission unit, placed on an area of the optical encoder chip, for emitting a light ray transmitted from the light emission unit into the external code wheel device through an air gap and the specific glass cover, the air gap being between the specific glass cover and the light emission unit;
at least one photo diode array, for receiving and sensing the light ray reflected from the external code wheel device and penetrated through the specific glass cover; and
at least one partition unit, configured and placed between the light emission unit and the at least one photo diode array, for blocking an internal light ray directed transmitted into the at least one photo diode array and for decreasing a light refraction from the specific glass cover emitted by the light emission unit.

2. The optical encoder device of claim 1, wherein the at least one photo diode array includes a first photo diode array and a second photo diode array, and the at least one partition unit includes a first partition bridge and a second partition bridge; and, the first partition bridge is placed between the first photo diode array and the light emission unit and used to separate a direct light emission from the light emission unit into the first photo diode array, and the second partition bridge is placed between the second photo diode array and the light emission unit and used to separate a direct light emission from the light emission unit into the second photo diode array.

3. The optical encoder device of claim 2, wherein the first photo diode array and the second photo diode array are different types.

4. The optical encoder device of claim 2, wherein the first partition bridge has a first partial height which does not contact the specific glass cover, and the second partition bridge has a second partial height which does not contact the specific glass cover; and, the first partial height is identical to the second partial height, and the specific glass cover is located at a plane which is parallel to another plane at which the optical encoder chip is located.

5. The optical encoder device of claim 2, wherein the first partition bridge has a first full height which contacts a first portion of the specific glass cover, and the second partition bridge has a second full height which contacts a second portion of the specific glass cover; and, the first full height is identical to the second full height, and the specific glass cover is located at a plane which is parallel to another plane at which the optical encoder chip is located.

6. The optical encoder device of claim 2, wherein the first partition bridge has a first height which contacts a first portion of the specific glass cover, and the second partition bridge has a second height which contacts a second portion of the specific glass cover; and, the first height is higher than the second full height, and the specific glass cover is located at a plane which is not parallel to another plane at which the optical encoder chip is located.

7. The optical encoder device of claim 6, wherein the first photo diode array is used to generate two quadrature output signals which are 90 degrees out of phase with each other, and the second photo diode array is an absolute photodiode which is used to generate a zero position reference and determine an absolute position.

8. The optical encoder device of claim 1, wherein the specific glass cover has an anti-reflection coating to decrease light reflection.

9. The optical encoder device of claim 1, wherein two ends of the at least one partition unit is configured to be not contacted with a surrounding of the specific aperture design.

10. The optical encoder device of claim 1, wherein two ends of the at least one partition unit contact two portions of a surrounding of the specific aperture design.

11. A method of an optical encoder device, to be paired with an external code wheel device, and the method comprises:
providing a housing;
providing a specific aperture design on a top of the housing to fit a specific glass cover;
providing and placing an optical encoder chip within an inner space of the housing;
placing a light emission unit on an area of the optical encoder chip to emit a light ray transmitted from the light emission unit into the external code wheel device through an air gap and the specific glass cover, the air gap being between the specific glass cover and the light emission unit;
providing at least one photo diode array to receive and sense the light ray reflected from the external code wheel device and penetrated through the specific glass cover; and
placing at least one partition unit between the light emission unit and the at least one photo diode array to block an internal light ray directed transmitted into the at least one photo diode array and to decrease a light refraction from the specific glass cover emitted by the light emission unit.

12. The method of claim 11, wherein the at least one photo diode array includes a first photo diode array and a second photo diode array, and the at least one partition unit includes a first partition bridge and a second partition bridge; and the method further comprises:
placing the first partition bridge between the first photo diode array and the light emission unit to separate a direct light emission from the light emission unit into the first photo diode array; and
placing the second partition bridge between the second photo diode array and the light emission unit to separate a direct light emission from the light emission unit into the second photo diode array.

13. The method of claim 12, wherein the first photo diode array and the second photo diode array are different types.

14. The method of claim 12, wherein the first partition bridge has a first partial height which does not contact the specific glass cover, and the second partition bridge has a second partial height which does not contact the specific glass cover; and, the first partial height is identical to the second partial height, and the specific glass cover is located at a plane which is parallel to another plane at which the optical encoder chip is located.

15. The method of claim 12, wherein the first partition bridge has a first full height which contacts a first portion of the specific glass cover, and the second partition bridge has a second full height which contacts a second portion of the specific glass cover; and, the first full height is identical to the second full height, and the specific glass cover is located at a plane which is parallel to another plane at which the optical encoder chip is located.

16. The method of claim 12, wherein the first partition bridge has a first height which contacts a first portion of the specific glass cover, and the second partition bridge has a second height which contacts a second portion of the specific glass cover; and, the first full height is higher than the second full height, and the specific glass cover is located at a plane which is not parallel to another plane at which the optical encoder chip is located.

17. The method of claim 16, further comprising:
using the first photo diode array to generate two quadrature output signals which are 90 degrees out of phase with each other; and
using the second photo diode array being an absolute photodiode to generate a zero position reference and determine an absolute position.

18. The method of claim 11, wherein the specific glass cover has an anti-reflection coating to decrease light reflection.

19. The method of claim 11, further comprising:
configuring two ends of the at least one partition unit to be not contacted with a surrounding of the specific aperture design.

20. The method of claim 11, further comprising:
configuring two ends of the at least one partition unit to contact two portions of a surrounding of the specific aperture design.
